(19) United States
(12) Patent Application Publication
(10) Pub. No.: US 2018/0299703 A1
(43) Pub. Date: Oct. 18, 2018

(54) Field of view enlarging clip-on mirror for use in combination with eyewear

(71) Applicant: Terry Gallant, Laval (CA)

(72) Inventor: Terry Gallant, Laval (CA)

(21) Appl. No.: 15/908,806

(22) Filed: Feb. 28, 2018

(30) Foreign Application Priority Data
Apr. 14, 2017 (GB) 1706039.3

(51) Int. Cl. G02C 9/04; G02C 7/14

(52) U.S. Cl. CPC G02C 9/04; G02C 2202/10; G02C 7/14

(57) ABSTRACT

A field of view enlarging clip-on mirror for use in combination with eyewear is provided. The field of view enlarging clip-on mirror includes a clip member having a clip insert designed to clip on the nose pad of eyewear. A mirror is attached to the clip member via a stem member. The mirror is designed to increase the field of view of the wearer providing a low cost, simple solution to alleviate the disadvantages caused to sufferers of Homonymous-Hemianopsia.

### CROSS-REFERENCE TO RELATED APPLICATIONS

The present application claims priority to United Kingdom Patent Application serial number GB1706039.3, filed on Apr. 14, 2017 entitled “Field of view enlarging clip-on mirror for use in combination with eyewear”, the disclosure of which is hereby incorporated in its entirety at least by reference.

### BACKGROUND OF THE INVENTION

### 1. Field of the Invention

The present invention generally relates to eyewear accessories, but more particularly to a field of view enlarging clip-on mirror for use in combination with eyewear.

### 2. Description of Related Art

There is a medical condition called Hemianopia, or Hemianopsia which is a type of vision loss that usually occurs after a stroke or brain injury which affects both eyes in the left or right side of the visual field. For instance, blindness in half the visual field, usually on one side of the vertical mid line. The most common causes of this damage are stroke, brain tumor, and trauma. This condition makes it difficult or nearly impossible for people to accomplish activities that most would take for granted, such as driving, or simply walking in an unknown environment. In everyday life, this can cause injury as one afflicted by this condition could bump into walls, objects, or even people. Therefore, patients with Hemianopia often stay at home or avoid places filled with people, which affects their quality of life.

Various patents have attempted to resolve this problem, for example, U.S. Pat. No. 4,155,633 to Benavie describes a Homonymous-Hemianopsia corrective device, comprising first and second reflectors, providing corrected vision over an overall field of view which is greater than the limited angular field of view of uncorrected vision.

U.S. Pat. No. 5,139,323 to Schillo describes a training system for rehabilitation of Hemianopsia patients, including a first training device adapted to be placed before the eyes of a hemianopsia patient during a first phase of training, wherein the first training device has blocking means for substantially blocking the passing of light therethrough, and transmitting means for substantially passing light therethrough. The blocking means are disposed in the part of the field of vision outside of the scotoma, and the transmitting means is disposed in the part of the field of vision in which there is no longer any vision due to the scotoma. A second training device adapted to be placed before the eyes of a hemianopsia patient during a second phase of training, wherein the second training device has before each eye a light transmitting means for transmitting light before one of the eyes having applied thereto an indicator mark ranging from the boundary of the scotoma and the functional visual field toward the edge of the scotoma hat is remote from the functional visual field, for reminding the patient to turn his eyes in the direction of the scotoma when vision into that area is required.

U.S. Pat. No. 4,493,538 to Tolliver discloses a lateral view extender device for Homonymous Hemianopsia. The device is used on eyewear having a pair of lenses and a nose bridge separating the pair of lenses. The device includes a dichroic half lens having the combined optical properties of a reflector and a see through lens and means for fixing the dichroic half lens to the nose bridge of the eyewear in optical registry with one lens of the pair of lenses for providing at least one optical path through the one lens of the pair of lenses and the dichroic half lens and at least one other optical path over the dichroic half lens. The dichroic lens forms an interior angle with the one lens of the pair of lenses for providing mirror images on the dichroic lens within the one optical path thereby extending the lateral view of a person suffering from Homonymous Hemianopsia proportionally to the interior angle formed between the dichroic lens and the one lens of the pair of lenses.

U.S. Pat. No. 4,733,958 to Gorsich discloses an invention not specifically directed at Homonymous-Hemianopsia sufferer and which includes a rear view mirror worn by a user; the mirror including a clip for attachment either to the person's eyeglasses, hat, helmet, shoulder or the like, and a universal joint between the mirror and clip, for directionally aligning the mirror. This invention can be useful for bicycle riders.

The devices described hereinabove use rather complex systems that are big and bulky wherein the lenses are located in front of the frame and are not practical for everyday wear while performing everyday tasks. For example U.S. Pat. No. 5,139,323 to Schillo is described as a “training system for rehabilitation” which could be compared to physiotherapy. Not very suitable for everyday normal use. Consequently, there is thus a need for a simple low cost solution to alleviate the disadvantages caused to sufferers of homonymous-Hemianopsia.

### BRIEF SUMMARY OF THE INVENTION

In one embodiment of the present invention a field of view enlarging clip-on mirror for use in combination with eyewear is provided, the field of view enlarging clip-on mirror comprising is provided, comprising: a clip member extending integrally from a stem member; a mirror frame connected to the stem member via a connection, wherein the mirror frame is configured to hold a mirror; a clip insert sized and shaped conforming to the clip member, wherein the clip insert is configured to clip to a nose pad of the eyewear such that a user having a field of view using the eyewear increases the field of view.

In one embodiment, the clip member is constructed from a U-shape. In one embodiment, the mirror and the mirror frame are oval shaped. In another embodiment, the mirror includes a soft rounded circumferential edge configured to minimize skin irritation with the user the event of facial contact during use. In one embodiment, the clip insert is constructed from a soft rubber like material that is configured to increase a frictional engagement and aid in securing the field of view enlarging clip-on mirror to the nose pad. In yet another embodiment, the mirror is constructed of a shatterproof reflective material. In one embodiment, the mirror is constructed from an aluminum film over a substrate of polycarbonate. In one embodiment, the mirror is in a fixed position relative to the nose pad with a fixed angled orientation relative to a frame of the eyewear such that the field of view is maximized. In another embodiment, the field of view is increased at least 30 degrees horizontally and 70 degrees vertically. In yet another embodiment, the mirror provides Hemianopia impaired viewing without inhibiting a standard visual field of the user.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view illustrating a field of view enlarging clip-on mirror for use in combination with eyewear according to an embodiment of the present invention;

FIG. 2 is a perspective view illustrating a field of view enlarging clip-on mirror according to an embodiment of the present invention;

FIG. 3 is an exploded view illustrating a field of view enlarging clip-on mirror according to an embodiment of the present invention; and,

FIG. 4 is a front view illustrating a field of view enlarging clip-on mirror for use in combination with eyewear according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a field of view enlarging clip-on mirror for use in combination with eyewear.

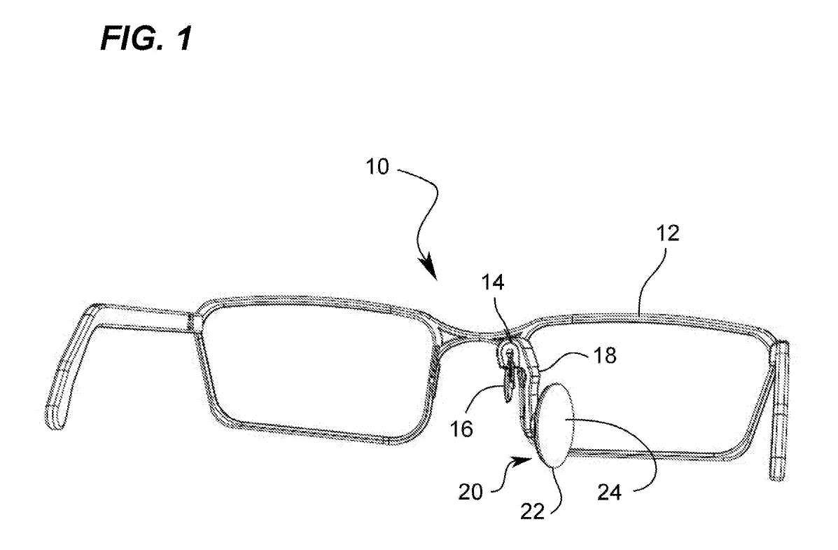

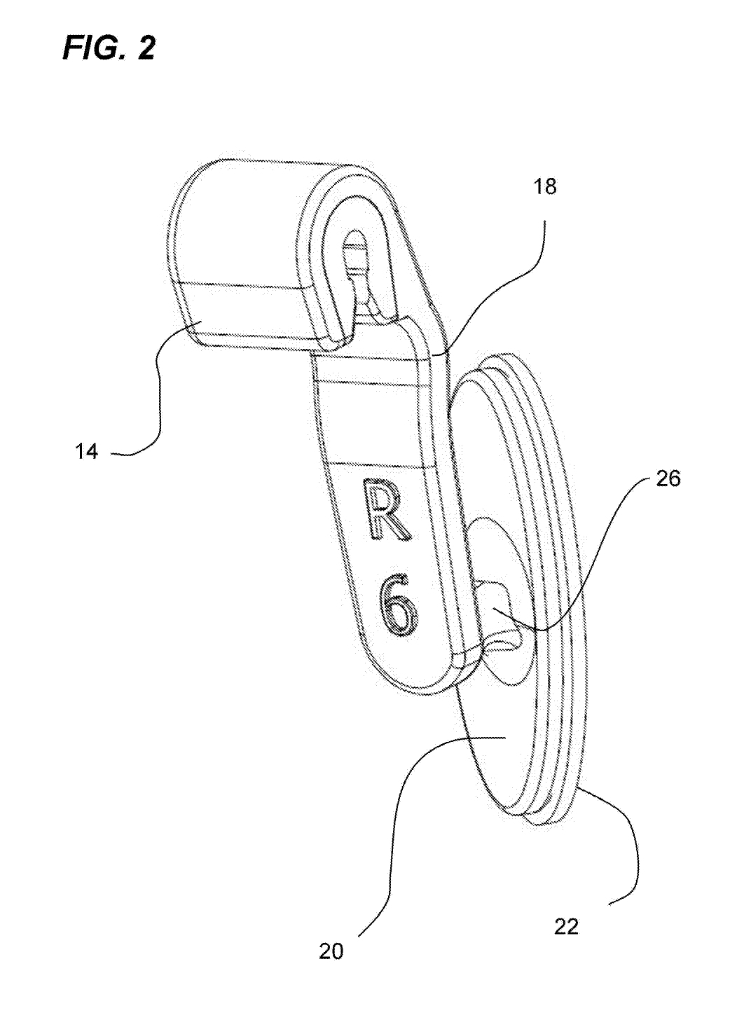

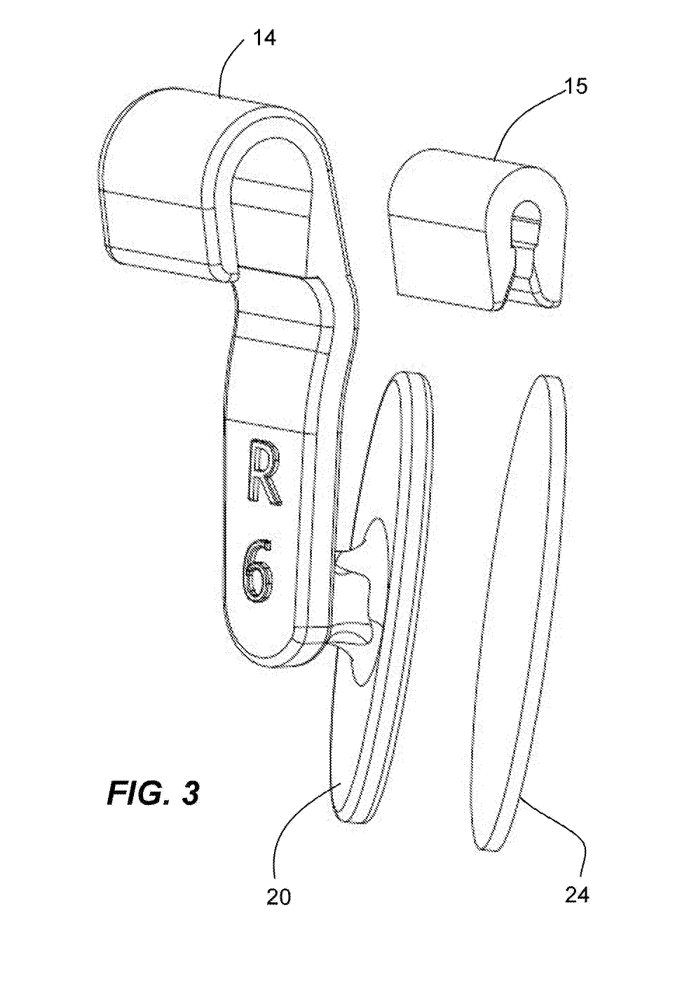

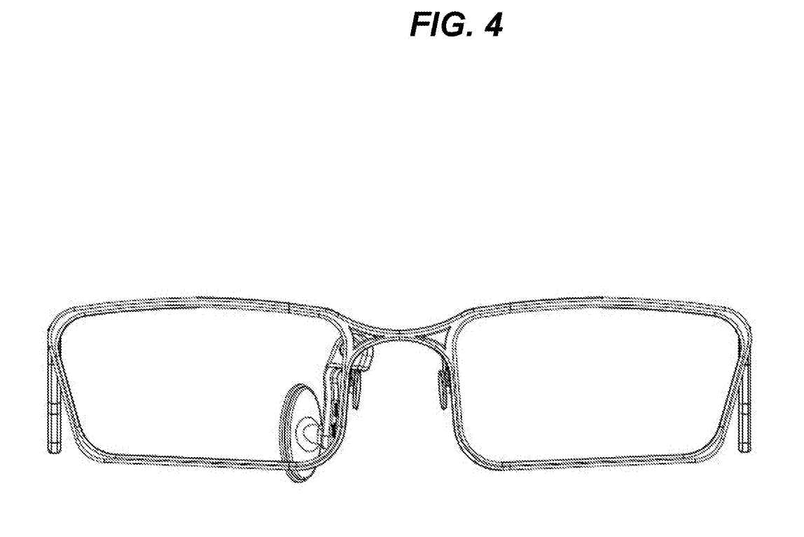

Referring now to any of the accompanying FIGS. 1-4, a field of view enlarging clip-on mirror 10 for use in combination with eyewear is provided. The clip-on mirror is comprises a clip member 14 configured to engage nose pad 16. More specifically, clip member 14 is frictionally engaged and clipped on nose pad 16. In one embodiment, the clip member has a U-shape. The nose pad is attached to eyewear frame 12 as well known in the art. In one embodiment, a clip insert 15 is sized and shaped to conform to clip member 14. Preferably, the clip insert is constructed from a soft rubber like material that is configured increase the frictional engagement and aid in securing the clip member to the nose pad.

In one embodiment, the clip-on mirror further comprises a stem member 18 extending integrally from the clip member. It is a particular advantage of the present invention to provide a mirror 24 configured to extend and maximum a field of view for the intended wearer. That is, it is a particular object of the present invention to provide a greater corrected field of view compared to an uncorrected field of view. This will be discussed in greater detail below.

In one embodiment, a mirror frame 20 is provided, wherein the mirror frame is configured to hold the mirror, via adhesion or any other suitable means. In one embodiment, the mirror has a soft rounded circumferential edge 22, a useful feature of the present invention, minimizing skin irritation with the wearer's face in the event of contact during use. In one embodiment, the mirror and corresponding mirror frame is of ellipse shape, and preferably oval shaped. The mirror frame is attached to the stem member via connection 26.

Preferably, the mirror is constructed with a shatterproof reflective material to eliminate injury concerns. In one embodiment, the mirror is constructed from aluminum, such as aluminum film, over a substrate of polycarbonate. It is well known in the art, that polycarbonate is a commonly used material in safety glasses.

During use, the user or wearer of the eyewear attaches the present invention to the nose pad as illustrated. Advantageously, the placement of the mirror close to the nose pad, as well as the orientation of the mirror's position (angle relative to the frame), is originally set to maximize the field of view without obstructing the current field of view. This allows for an improvement of 30 degrees horizontally and offers 70 degrees vertically. More specifically, the mirror allows the user to see part of the Hemianopia side without harming the side of the healthy visual field. Preferably, the mirror's position and orientation is fixed, and not modifiable to maximum the field of view, without requiring adjustments. If the user suffers from complete Hemianopia, the increase in field of view, or corrected field of view horizontally is between 50 degrees and 80 degrees, allowing the user to see obstacles (or people) on the side. Vertically, the increase in field of view is approximately 70 continuous degrees. Further, the user does not need to look directly into the mirror to benefit from the improvement in the visual field. The user can read, look forward, or sweep his gaze sideways without his vision being affected by the presence of the mirror.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

What is claimed is:

1. A field of view enlarging clip-on mirror for use in combination with eyewear, the field of view enlarging clip-on mirror comprising:
a clip member extending integrally from a stem member;
a mirror frame connected to the stem member via a connection, wherein the mirror frame is configured to hold a mirror;
a clip insert sized and shaped conforming to the clip member, wherein the clip insert is configured to clip to a nose pad of the eyewear such that a user having a field of view using the eyewear increases the field of view.

2. The field of view enlarging clip-on mirror for use in combination with eyewear of claim 1, wherein the clip member is constructed from a U-shape.

3. The field of view enlarging clip-on mirror for use in combination with eyewear of claim 1, wherein the mirror and the mirror frame are oval shaped.

4. The field of view enlarging clip-on mirror for use in combination with eyewear of claim 3, wherein the mirror includes a soft rounded circumferential edge configured to minimize skin irritation with the user the event of facial contact during use.

5. The field of view enlarging clip-on mirror for use in combination with eyewear of claim 1, wherein the clip insert is constructed from a soft rubber like material that is configured to increase a frictional engagement and aid in securing the field of view enlarging clip-on mirror to the nose pad.

6. The field of view enlarging clip-on mirror for use in combination with eyewear of claim 1, wherein the mirror is constructed of a shatterproof reflective material.

7. The field of view enlarging clip-on mirror for use in combination with eyewear of claim 6, the mirror is constructed from an aluminum film over a substrate of polycarbonate.

8. The field of view enlarging clip-on mirror for use in combination with eyewear of claim 1, wherein the mirror is in a fixed position relative to the nose pad with a fixed angled orientation relative to a frame of the eyewear such that the field of view is maximized.

9. The field of view enlarging clip-on mirror for use in combination with eyewear of claim 8, wherein the field of view is increased at least 30 degrees horizontally and 70 degrees vertically.

10. The field of view enlarging clip-on mirror for use in combination with eyewear of claim 8, wherein the mirror provides Hemianopia impaired viewing without inhibiting a standard visual field of the user.
